(19) United States
(12) Patent Application Publication
(10) Pub. No.: US 2019/0019464 A1
(43) Pub. Date: Jan. 17, 2019

(54) IMAGE DISPLAY METHOD AND LIQUID CRYSTAL DISPLAY DEVICE

(71) Applicant: Wuhan China Star Optoelectronics Technology Co., Ltd., Wuhan, Hubei (CN)

(72) Inventor: Zhenzhou XING, Shenzhen, Guangdong (CN)

(73) Assignee: Wuhan China Star Optoelectronics Technology Co., Ltd., Wuhan, Hubei (CN)

(21) Appl. No.: 15/556,565

(22) PCT Filed: Aug. 17, 2017
(86) PCT No.: PCT/CN2017/097863

§ 371 Date: Sep. 7, 2017

(30) Foreign Application Priority Data
Jul. 14, 2017 (CN) 201710574324.X

(51) Int. Cl. G09G 3/36

(52) U.S. Cl. CPC G09G 3/3607; G09G 2310/0264; G09G 3/3648

(57) ABSTRACT

The present disclosure discloses an image display method and a liquid crystal display device. The image display method including: obtaining four-color sub-pixel data of each pixel unit of the image frame to be displayed, the four-color sub-pixel data including a white grayscale value; dividing the white grayscale value into a first white grayscale value and a second white grayscale value; the first white gray scale value and the second white gray scale value are combined with the corresponding gray scale value to form a first image frame and a second image frame, respectively; outputting the first image frame and the second image frame sequentially to the liquid crystal panel. In the above-described manner, the present disclosure can improve the color drift when viewing the liquid crystal panel at a large viewing angle, thereby improving the display quality of the liquid crystal panel.

### FIELD OF THE DISCLOSURE

The present disclosure relates to a liquid crystal field, and more particularly to a image display method and a liquid crystal display device.

### BACKGROUND OF THE DISCLOSURE

RGBW four primary color display technology in the RGW three primary colors on the basis of the increase in white pixels, which can improve the penetration of the LCD panel; at the same time, by using the sub-pixel sharing algorithm in the same degree of resolution under the premise of reducing the LCD panel ⅓ the number of pixels, to achieve the risk of reducing the production of high resolution, reducing the backlight power consumption of 40% at the same time, improve the image contrast effect, so RGBW LCD panel in the future has a broad space for development.

However, the RGBW liquid crystal panel also has an inherent drawback that the optical luminance curve can not conform to gamma 2.2 when a large viewing angle is viewed, i.e., a color shift phenomenon occurs. And the greater the viewing angle, the more obvious the color drift phenomenon.

FIG. 1 is a gamma curve of a prior art liquid crystal panel at different viewing angles. As shown in FIG. 1, when the viewing angle is 0°, the gamma value is 2.2. As the viewing angle changes from 0° to 30° to the angle of oblique angle of 60°, the gamma curve corresponding to different viewing angles deviates from the gamma curve corresponding to the viewing angle of 0°, which makes the phenomenon of color drift more and more obvious.

Therefore, how to improve the RGBW LCD panel color drift phenomenon, thereby improving the RGBW LCD panel display quality is an urgent problem to be solved.

### SUMMARY OF THE DISCLOSURE

A technical problem that has been mainly solved by the present disclosure is to provide an image display method and a liquid crystal display device capable of improving color drift.

In order to solve the above-mentioned technical problems, a technical solution adopted by the present disclosure is: providing a liquid crystal panel, the liquid crystal panel including a plurality of pixel units, each of the pixel units including four-color sub-pixels; obtaining four-color sub-pixel data of each pixel unit of the image frame to be displayed, the four-color sub-pixel data including a red grayscale value, a green grayscale value, a blue grayscale value and a white grayscale value; dividing the white grayscale value into a first white grayscale value and a second white grayscale value according to a predetermined rule; the first white gray scale value and the second white gray scale value are combined with the corresponding red gray scale value, the green gray scale value and the blue gray scale value to form a first image frame and a second image frame, respectively; outputting the first image frame and the second image frame sequentially to the liquid crystal panel; wherein the first white gray scale value is less than the white gray scale value and the white gray scale value is less than the second white gray scale value; wherein the update frequency of the first image frame and the second image frame is twice the update frequency of the image frame to be displayed.

In order to solve the above-mentioned technical problem, another aspect of the present disclosure is to provide an image display method including: providing a liquid crystal panel, the liquid crystal panel including a plurality of pixel units, each of the pixel units including four-color sub-pixels; obtaining four-color sub-pixel data of each pixel unit of the image frame to be displayed, the four-color sub-pixel data including a red grayscale value, a green grayscale value, a blue grayscale value and a white grayscale value; dividing the white grayscale value into a first white grayscale value and a second white grayscale value according to a predetermined rule; the first white gray scale value and the second white gray scale value are combined with the corresponding red gray scale value, the green gray scale value and the blue gray scale value to form a first image frame and a second image frame, respectively; outputting the first image frame and the second image frame sequentially to the liquid crystal panel.

In order to solve the above-mentioned technical problem, a further aspect of the present disclosure is to provide a liquid crystal display device including: a liquid crystal panel including a plurality of pixel units, each of the pixel units including four-color sub-pixels; a control circuit coupled to the liquid crystal panel for obtaining four-color sub-pixel data of each pixel unit of the image frame to be displayed, the four-color sub-pixel data includes a red grayscale value, a green grayscale value, a blue grayscale value, and a white grayscale value, the white grayscale value is divided into a first white grayscale value and a second white grayscale value according to a predetermined rule, the first white gray scale value and the second white gray scale value are combined with the corresponding red gray scale value, the green gray scale value and the blue gray scale value to form a first image frame and a second image frame, respectively, and the first image frame and the second image frame are sequentially output to the liquid crystal panel.

The beneficial effects of the present disclosure are: the image display method and the liquid crystal display device of the present disclosure divide the white gray scale value of the image frame to be displayed into a first white gray scale value and a second white gray scale value, the first gray scale value, the second white gray scale value and the red grayscale value, the green gray scale value and the blue gray scale value in the image frame to be displayed are combined to form the first image frame and the second image frame, the first image frame and the second image frame are successively output to the liquid crystal panel. In the above-described manner, the present disclosure can improve the color drift when viewing the liquid crystal panel at a large viewing angle, thereby improving the display quality of the liquid crystal panel.

### BRIEF DESCRIPTION OF THE DRAWINGS

FIG. 1 is a gamma curve of a prior art liquid crystal panel at different viewing angles;

FIG. 2 is a schematic structural view of a liquid crystal display device according to an embodiment of the present disclosure;

FIG. 3 is a comparison chart of the observation curve when the LCD panel is viewed before and after the improvement;

FIG. 4 is a flowchart of an image display method according to an embodiment of the present disclosure.

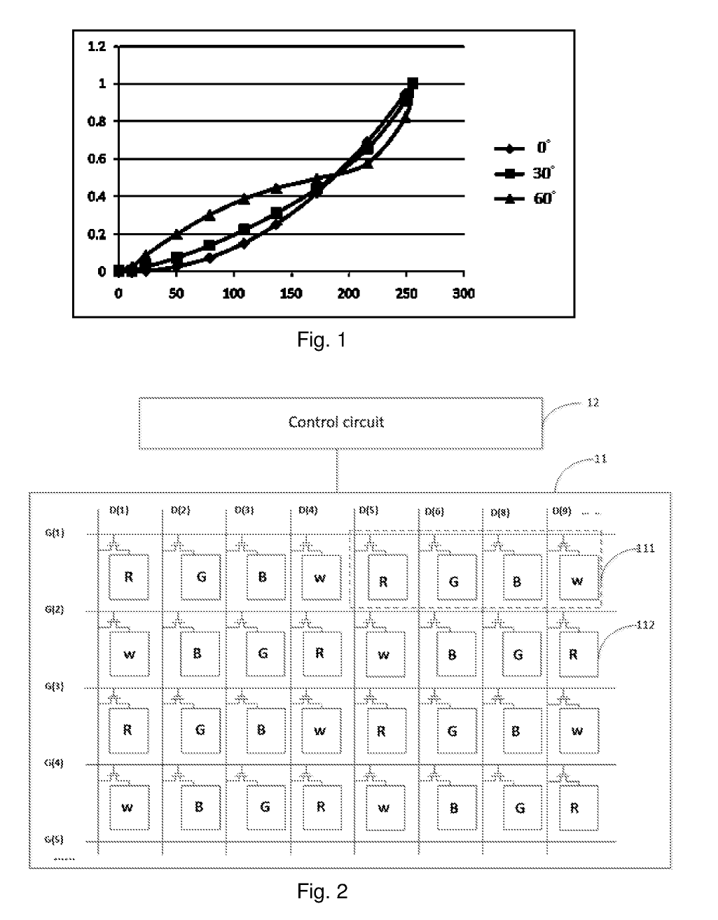

### DETAILED DESCRIPTION OF PREFERRED EMBODIMENTS

The use of certain words in the specification and claims to refer to specific components, it will be understood by those skilled in the art that the manufacturer may use different terms to refer to the same components. The present specification and claims do not serve as a means of distinguishing components by differences in names, but rather as a basis for distinguishing functional differences in components. The present disclosure will now be described in detail with reference to the accompanying drawings and examples.

FIG. 2 is a schematic structural view of a liquid crystal display device according to an embodiment of the present disclosure. As shown in FIG. 2, the liquid crystal display device includes a liquid crystal panel 11 and a control circuit 12.

The liquid crystal panel 11 includes a plurality of data lines D (N) (N is a natural number), a plurality of scanning lines G (N) (N is a natural number), and a plurality of pixel units 111. Each pixel unit 111 includes four-color sub-pixels 112, wherein the four-color sub-pixel 112 is a red sub-pixel R, a green sub-pixel G, a blue sub-pixel B, and a white sub-pixel W, and each sub-pixel 112 is connected to a corresponding one of a data line and a scanning line.

Preferably, the pixel units 111 of the liquid crystal panel 11 are repeatedly arranged in two rows, wherein the four-color sub-pixels in the first row and the second row of pixel units 111 are arranged in the opposite order.

In the present embodiment, the first row pixel unit 111 is repeatedly arranged in the order of the red subpixel R, the green subpixel G, the blue subpixel B, and the white subpixel W, the second row pixel unit 111 is repeatedly arranged in the order of the white subpixel W, the blue subpixel B, the green subpixel G, and the red subpixel R. It will be understood by those skilled in the art that the ordering of the sub-pixels in the present embodiment is by way of example only and that the present disclosure is not limited thereto.

The control circuit 12 is coupled to the liquid crystal panel 11 for obtaining the four-color sub-pixel data of each pixel unit of the image frame to be displayed, the four-color sub-pixel data includes the red grayscale value, the green grayscale value, the blue grayscale value, and the white grayscale value, the white grayscale value is divided into a first white grayscale value and a second white grayscale value according to a predetermined rule, the first white gray scale value and the second white gray scale value are combined with the corresponding red gray scale value, the green gray scale value and the blue gray scale value to form the first image frame and the second image frame, respectively, and outputs the first image frame and the second image frame sequentially to the liquid crystal panel 11.

Preferably, the first white grayscale value is less than the white grayscale value and the white grayscale value is less than the second white grayscale value. Specifically, the sum of the first white grayscale value and the second white grayscale value is equal to twice the white grayscale value. For example, assuming that the white gray scale value of the image frame to be displayed is 127, the first white grayscale value may be 122 and the second white grayscale value may be 132.

Preferably, the white gray scale value of the liquid crystal panel 12 includes 256 gray levels, from 0 to 255, where the highest gray scale in the white grayscale value is 255.

In the present embodiment, the operation of sequentially outputting the first image frame and the second image frame to the liquid crystal panel 11 is that the control circuit 12 controls the gate of the transistor of the corresponding subpixel 112 by controlling the scanning line G (N), the first image frame is displayed on the liquid crystal panel 11 by applying a voltage corresponding to each sub-pixel gray scale value to the source of the corresponding sub-pixel 112 in accordance with the four-color sub-pixel data control data line D (N) in the first image frame, the above operation is repeated to realize the display of the second image frame.

In the present embodiment, the update frequency of the first image frame and the second image frame is twice the update frequency of the image frame to be displayed. Wherein the update frequency of the first image frame or the second image frame can be understood as the refresh rate of the liquid crystal panel. For example, if the update frequency of the image frame to be displayed is 60 Hz, the update frequency of the first image frame and the second image frame is 120 Hz.

It will be understood by those skilled in the art that in the present embodiment, by dividing the image frame to be displayed into two image frames, i.e., the first image frame and the second image frame, specifically, the white sub-pixel in the liquid crystal panel is driven by dividing the white gray scale value in the image frame to be divided into the first white gray scale value in the first image frame and the second white gray scale value in the second image frame, due to the human eye vision effect, the final human eye is still observed to be displayed in the image frame white grayscale value of the brightness, the liquid crystal molecules exhibit different taper angles due to variations in the voltage of the driving white sub-pixels at the time of display of the first image frame and the second image frame, i.e., different gamma curve characteristics, so the large angle of view, the LCD panel Gamma curve can be well improved, which can improve the color of the LCD panel drift phenomenon, and ultimately improve the LCD panel display quality.

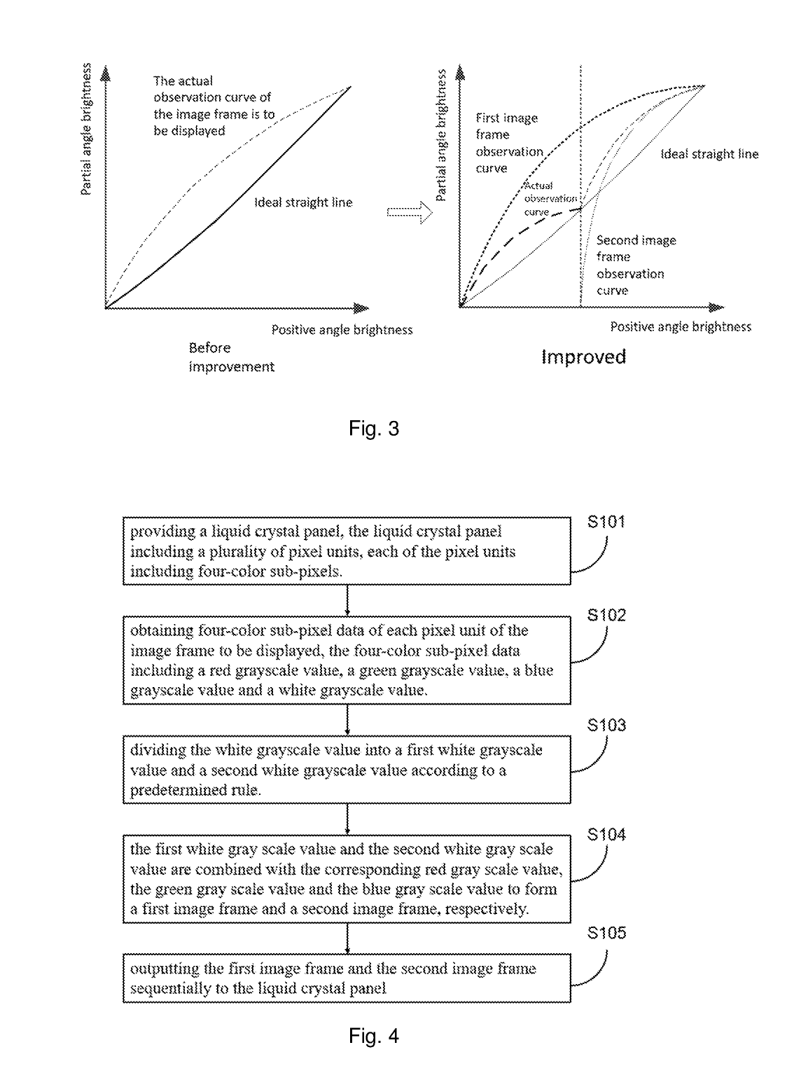

FIG. 3 is a comparison chart of the observation curve when the LCD panel is viewed before and after the improvement. As shown in FIG. 3, the image frame to be displayed is directly output to the liquid crystal panel (i.e., before the improvement), the image frame to be displayed is divided into the first image frame and the second image frame are sequentially output to the liquid crystal panel (i.e., after improvement), the observation angle of the positive angle of view and the angle of the angle of view is closer to the ideal straight line, that is, in the large viewing angle observation, with a better display.

FIG. 4 is a flowchart of an image display method according to an embodiment of the present disclosure, the method is based on the liquid crystal display device shown in FIG. 2. As shown in FIG. 4, the method including the steps of:

step S101: providing a liquid crystal panel, the liquid crystal panel including a plurality of pixel units, each of the pixel units including four-color sub-pixels.

In step S101, the pixel unit includes four-color sub-pixels, wherein the four-color sub-pixels are red sub-pixels, green sub-pixels, blue sub-pixels, and white sub-pixels, respectively.

The pixel units of the liquid crystal panel are repeatedly arranged in two rows, wherein the four-color sub-pixels in the first row and the second row of pixel units are arranged in the opposite order. For example, the first row of pixel cells is repeatedly arranged in the order of the red subpixel R, the green subpixel G, the blue subpixel B, and the white subpixel W, the second row of pixel cells is arranged in the order of the white subpixel W, the blue subpixel B, the green subpixel G, and the red subpixel R.

Step S102: obtaining four-color sub-pixel data of each pixel unit of the image frame to be displayed, the four-color sub-pixel data including a red grayscale value, a green grayscale value, a blue grayscale value and a white grayscale value.

Step S103: dividing the white grayscale value into a first white grayscale value and a second white grayscale value according to a predetermined rule.

In step S103, the first white grayscale value is smaller than the white grayscale value and the white grayscale value is smaller than the second white grayscale value. Preferably, the sum of the first white grayscale value and the second white grayscale value is equal to twice the white grayscale value.

Step S104: the first white gray scale value and the second white gray scale value are combined with the corresponding red gray scale value, the green gray scale value and the blue gray scale value to form a first image frame and a second image frame, respectively.

In step S104, the image frame to be displayed is divided into two different image frames, i.e., the first image frame and the second image frame, wherein the white gray scale value in the first image frame is the first white gray scale value, the gray scale value in the second image frame is the second white gray scale value, the gray scale value of the other colors is the same as the gray scale value of the corresponding color in the image frame to be displayed.

Step S105: outputting the first image frame and the second image frame sequentially to the liquid crystal panel.

In step S105, the update frequency of the first image frame and the second image frame is twice the update frequency of the image frame to be displayed. For example, if the update frequency of the image frame to be displayed is 60 Hz, the update frequency of the first image frame and the second image frame is 120 Hz.

Wherein the first image frame and the second image frame are successively output to the liquid crystal panel, and the brightness of the white gray scale value of the image frame to be displayed is finally observed by the human eye due to the human visual fixation effect; but the liquid crystal molecules at different times into different tilt angle, so the large viewing angle, the LCD panel Gamma curve can be well improved.

The beneficial effects of the present disclosure are: the image display method and the liquid crystal display device of the present disclosure divide the white gray scale value of the image frame to be displayed into a first white gray scale value and a second white gray scale value, the first gray scale value, the second white gray scale value and the red grayscale value, the green gray scale value and the blue gray scale value in the image frame to be displayed are combined to form the first image frame and the second image frame, the first image frame and the second image frame are successively output to the liquid crystal panel. In the above-described manner, the present disclosure can improve the color drift when viewing the liquid crystal panel at a large viewing angle, thereby improving the display quality of the liquid crystal panel.

The foregoing is merely an embodiment of the present disclosure and is not intended to limit the scope of the disclosure as defined by equivalents or equivalent processes of the present disclosure and the accompanying drawings, or directly or indirectly, in other related technical fields, are likewise included within the scope of the patent protection of the present disclosure.

What is claimed is:

1. An image display method, wherein, the method comprises:
providing a liquid crystal panel, the liquid crystal panel comprising a plurality of pixel units, each of the pixel units comprising four-color sub-pixels;
obtaining four-color sub-pixel data of each pixel unit of the image frame to be displayed, the four-color sub-pixel data comprising a red grayscale value, a green grayscale value, a blue grayscale value and a white grayscale value;
dividing the white grayscale value into a first white grayscale value and a second white grayscale value according to a predetermined rule;
the first white gray scale value and the second white gray scale value are combined with the corresponding red gray scale value, the green gray scale value and the blue gray scale value to form a first image frame and a second image frame, respectively;
outputting the first image frame and the second image frame sequentially to the liquid crystal panel;
wherein the first white gray scale value is less than the white gray scale value and the white gray scale value is less than the second white gray scale value;
wherein the update frequency of the first image frame and the second image frame is twice the update frequency of the image frame to be displayed.

2. The display method according to claim 1, wherein the sum of the first white gray scale value and the second white gray scale value is equal to twice the value of the white gray scale value.

3. The display method according to claim 1, wherein the pixel units of the liquid crystal panel are repeatedly arranged in two rows, wherein the arrangement of the four-color sub-pixels in the first row and the second row is reversed.

4. The display method according to claim 3, wherein the first row of the pixel units is repeatedly arranged in the order of a red subpixel, a green subpixel, a blue subpixel, and a white subpixel, the pixel units described in the second row are arranged in the order of white sub-pixels, blue sub-pixels, green sub-pixels, and red sub-pixels.

5. An image display method, wherein the method comprises:
providing a liquid crystal panel, the liquid crystal panel comprising a plurality of pixel units, each of the pixel units comprising four-color sub-pixels;
obtaining four-color sub-pixel data of each pixel unit of the image frame to be displayed, the four-color sub-pixel data comprising a red grayscale value, a green grayscale value, a blue grayscale value and a white grayscale value;
dividing the white grayscale value into a first white grayscale value and a second white grayscale value according to a predetermined rule;
the first white gray scale value and the second white gray scale value are combined with the corresponding red gray scale value, the green gray scale value and the blue gray scale value to form a first image frame and a second image frame, respectively;
outputting the first image frame and the second image frame sequentially to the liquid crystal panel.

6. The display method according to claim 5, wherein the first white gray scale value is less than the white gray scale value and the white gray scale value is less than the second white gray scale value.

7. The display method according to claim 6, wherein the sum of the first white gray scale value and the second white gray scale value is equal to twice the value of the white gray scale value.

8. The display method according to claim 5, wherein the update frequency of the first image frame and the second image frame is twice the update frequency of the image frame to be displayed.

9. The display method according to claim 5, wherein the pixel units of the liquid crystal panel are repeatedly arranged in two rows, wherein the arrangement of the four-color sub-pixels in the first row and the second row is reversed.

10. The display method according to claim 9, wherein the first row of the pixel units is repeatedly arranged in the order of a red subpixel, a green subpixel, a blue subpixel, and a white subpixel, the pixel units described in the second row are arranged in the order of white sub-pixels, blue sub-pixels, green sub-pixels, and red sub-pixels.

11. A liquid crystal display device, wherein, the display device comprises:
a liquid crystal panel comprising a plurality of pixel units, each of the pixel units comprising four-color sub-pixels;
a control circuit coupled to the liquid crystal panel for obtaining four-color sub-pixel data of each pixel unit of the image frame to be displayed, the four-color sub-pixel data comprises a red grayscale value, a green grayscale value, a blue grayscale value, and a white grayscale value, the white grayscale value is divided into a first white grayscale value and a second white grayscale value according to a predetermined rule, the first white gray scale value and the second white gray scale value are combined with the corresponding red gray scale value, the green gray scale value and the blue gray scale value to form a first image frame and a second image frame, respectively, and the first image frame and the second image frame are sequentially output to the liquid crystal panel.

12. The display device according to claim 11, wherein the first white gray scale value is less than the white gray scale value and the white gray scale value is less than the second white gray scale value.

13. The display device according to claim 12, wherein the sum of the first white gray scale value and the second white gray scale value is equal to twice the value of the white gray scale value.

14. The display device according to claim 11, wherein the update frequency of the first image frame and the second image frame is twice the update frequency of the image frame to be displayed.
